(19) United States
(12) Patent Application Publication
(10) Pub. No.: US 2014/0379680 A1
(43) Pub. Date: Dec. 25, 2014

(54) GENERATING SEARCH QUERY SUGGESTIONS

(71) Applicants: Qiliang Chen, Beijing (CN); Weihua Tan, Beijing (CN); Guangqiang Zhang, Beijing (CN); Zhuohao Wu, Beijing (CN)

(72) Inventors: Qiliang Chen, Beijing (CN); Weihua Tan, Beijing (CN); Guangqiang Zhang, Beijing (CN); Zhuohao Wu, Beijing (CN)

(21) Appl. No.: 13/824,099

(22) PCT Filed: Sep. 21, 2010
(86) PCT No.: PCT/CN2010/077216

§ 371 Date: Dec. 3, 2013

(51) Int. Cl. G06F 17/30

(52) U.S. Cl. CPC G06F 17/3064; G06F 17/30864; G06F 17/30654
USPC 707/706

(57) ABSTRACT

Methods, systems, apparatus, including computer program products, for generating search query suggestions. In one aspect, a method includes receiving a first textual input in a first form; automatically sending, before a user submits a request for a search and after waiting a predetermined amount of time after receiving each token of the first textual input, the first textual input to a suggestion service; receiving a set of first input suggestions in the first form, where each first input suggestion is textually different from the first textual input and selectable as an alternative to the first textual input; receiving a set of second input suggestions, where each second input suggestion is a representation of a first input suggestion in a different, second form and selectable as an alternative to the first textual input; and providing the first input suggestions and the second input suggestions for display in a user interface.

### BACKGROUND

This specification relates to digital data processing, and in particular, to computer-implemented suggestion services.

Conventional suggestion services provide search query suggestions as alternatives to input search queries. For example, a conventional search engine can include a query input field that receives an input search query. In response to receiving the input search query, a conventional suggestion service can provide search query suggestions for the input search query. A user can select a search query suggestion for use as a search query.

### SUMMARY

This specification describes technologies relating to generation of search query suggestions.

In general, one aspect of the subject matter described in this specification can be embodied in methods that include the actions of receiving in a data processing device a first textual input entered in a search engine query input field by a user, where the first textual input is in a first form; automatically sending from the device, before the user submits a request for a search and after waiting a predetermined amount of time after receiving each token of the first textual input, the first textual input to a suggestion service; receiving a set of first input suggestions in the first form, where each first input suggestion is textually different from the first textual input and selectable as an alternative to the first textual input; receiving a set of second input suggestions, where each second input suggestion is a representation of a first input suggestion in a different, second form and selectable as an alternative to the first textual input; and providing the first input suggestions for display in a first portion of a user interface and the second input suggestions for display in a second portion of the user interface, where the first portion is distinct from the second portion. Other embodiments of this aspect include corresponding systems, apparatus, and computer program products.

These and other embodiments can optionally include one or more of the following features. The displaying includes displaying each second input suggestion such that the second input suggestion is aligned with a respective first input suggestion that the second input suggestion represents. The method further includes receiving a user selection of a first input suggestion or a second input suggestion; and sending the selection in a request for a search. The device is an intermediate server that receives the first textual input from a client computer. The device is a client computer directly controlled by the user.

Displaying the first input suggestions and the second input suggestions includes displaying the first input suggestions in the first portion and the second input suggestions in the second portion of a same interface element in the user interface. The method further includes receiving user preferences specifying the second form. The first form is a first writing system, and the second form is a different, second writing system. The first form is for a first natural language, and the second form is for a different, second natural language. The first form is a first writing system for a first natural language, and the second form is the first writing system for a different, second natural language.

Particular embodiments of the subject matter described in this specification can be implemented to realize one or more of the following advantages. Automatically obtaining and displaying first input suggestions in a first form and second input suggestions that represent first input suggestions in a different, second form reduces how much user interaction is required to obtain alternatives to an input search query, e.g., alternatives in different writing systems or natural languages, and obtain information for the alternative forms (e.g., obtain translations without submitting a request for a search) or perform searches using one or more of the alternatives. Automatically obtaining these input suggestions may be of particular value in situations when a reduced number of user inputs is desirable, for instance due to restrictions of the user interface (e.g., in handheld devices or in voice-operated devices) or when the user is multitasking. Thus, reducing a number of user inputs needed can improve the operation efficiency, and safety in some situations, when performing searches.

In addition to saving time, providing input suggestions in different forms (e.g., transliterations and translations) can increase the precision, accuracy, and coverage of a search by capturing alternatives to the input search query that are directed to what a user may consider to be relevant to the search. Moreover, as only one request and, in some cases, one return data package may have to be sent, the reliability and speed of providing the suggestions can be improved. This can be advantageous in situations where the network connection may not be robust, e.g., where the connection includes certain wireless networks. Furthermore, there can be advantages on the server side in reducing the number of requests, as the resources of a server to which a request is addressed may be allocated more efficiently if confronted with a reduced number of different user requests. By providing suggestions to the user, the probability of receiving search queries which are already known to the server can be increased. The workload for the server can be reduced as the probability that the server may have already determined search results for a suggestion is increased. In such cases, an average time to serve search results to a user can be reduced.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example of a flow of data in some implementations of a system that generates input suggestions in different forms of representing natural languages.

FIG. 2 is a block diagram illustrating an example input suggestion aggregator.

FIG. 3 is a screenshot illustrating an example of a web page presenting a group of first input suggestions in a first form and a group of second input suggestions in a different, second form.

FIG. 4 is a flow chart showing an example process for automatically generating input suggestions in different forms of representing natural languages.

Like reference numbers and designations in the various drawings indicate like elements.

### DETAILED DESCRIPTION

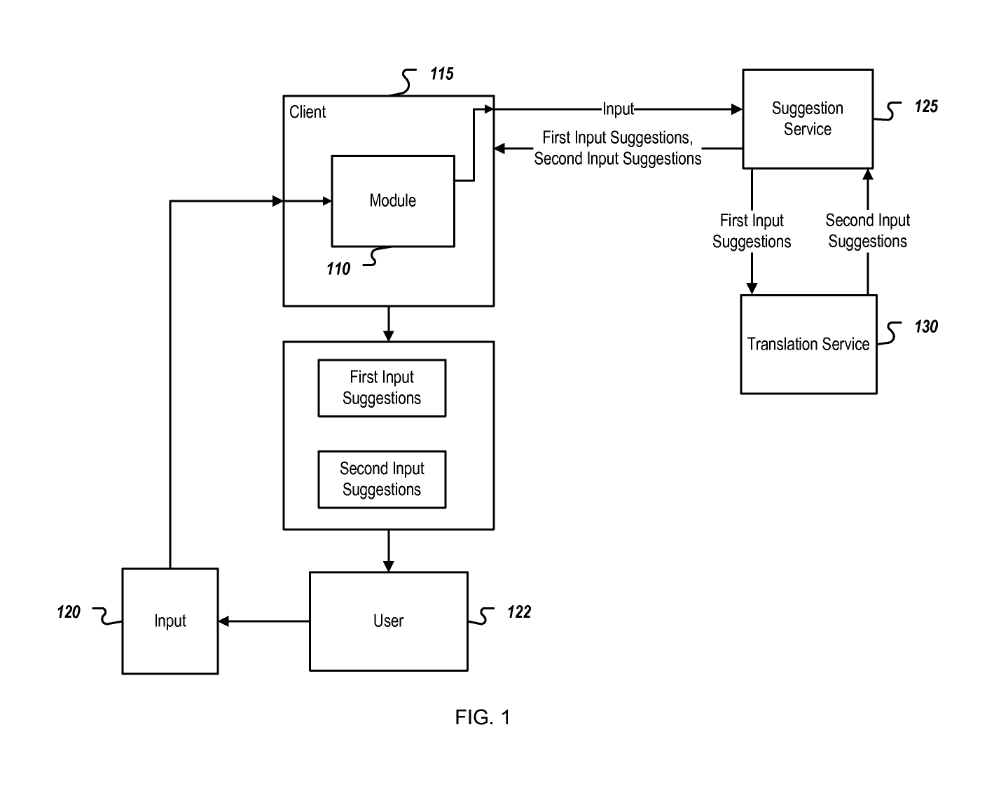

FIG. 1 is a block diagram illustrating an example of a flow of data in some implementations of a system that generates input suggestions in different forms of representing natural languages. A module 110, e.g., a JavaScript script, running on a client device 115 monitors input 120 received in a search engine query input field from a user 122. The input 120 is in a first form. The first form is a first writing system and used for a first natural language. As an example, the first writing system can be Hanzi (represented using Hanzi characters) and used for the first natural language Chinese. Some writing systems can be used to represent multiple natural languages. Such a writing system can be used with different sound systems (e.g., systems of phonemes) to encode meaning in multiple natural languages. As an example, the first writing system can be Latin (represented using Roman characters) and used for the natural language English or for the natural language Chinese, e.g., as used in Romanized Chinese.

In some implementations, the module 110 is plug-in software that is installed in a web browser running on the client device 115. In some alternative implementations, the module 110 is installed on an intermediate server that receives the input 120, e.g., from the client device 115. The module 110 receives the input 120 and automatically sends the input 120 to a suggestion service 125, as the input 120 is received. In some implementations, the suggestion service 125 is software running on a server (e.g., a server distinct from the intermediate server) that receives a textual input, e.g., a search query, and returns alternatives to the textual input, e.g., query suggestions. The suggestion service 125 determines a set of first input suggestions in the first form, and sends one or more of the first input suggestions to a translation service 130. The first input suggestions are alternatives to the input 120, e.g., expansions and completions.

In some implementations, the translation service 130 is software running on a server that receives textual input and returns alternatives to the textual input that are represented in different writing systems or natural languages, e.g. translations and transliterations. The translation service 130 identifies representations of the first input suggestions in a different, second form.

The different, second form can be a different writing system from and for a same natural language as the first form. In other words, a representation of a first input suggestion in the different, second form can be a transliteration. As an example, a first input suggestion can be a Hanzi character “ [symbol] ” (e.g., “car” in English) and an associated second input suggestion can be “chē” (e.g., a Romanized Chinese representation of “ [symbol] ”).

The different, second form can be a different writing system from and for a different natural language from the first form. In other words, a representation of a first input suggestion in the different, second form can be a translation in a different writing system. As an example, a first input suggestion can be an English word “car” and an associated second input suggestion can be “ [symbol] ” (e.g., a Hanzi character meaning “car”).

Furthermore, the different, second form can be a same writing system as and for a different natural language from the first form. In other words, a representation of a first input suggestion in the different, second form is a translation in a same writing system. As an example, a first input suggestion can be an English word “car” and an associated second input suggestion can be “chē” (e.g., a Romanized Chinese representation of a Hanzi character “ [symbol] ” that can mean “car”).

In some implementations, the user 122 specifies the different, second form by setting user preferences. In some implementations where the representations of the first input suggestions in the different, second form include translations, the module 110 automatically selects the different, second form from frequently used language pairs. As an example, when the input 120 is in a first natural language, the module 110 identifies, without further user intervention, the most popular language pair that includes the first natural language. The module 110 then selects the other natural language of the pair for the different, second form. The writing system of the different, second form can be the same as or different from the writing system of the input 120.

In some implementations, the module 110 automatically selects the different, second form from frequently used writing system pairs. As an example, the module 110 identifies, without further user intervention, the most popular writing system pair that includes a first writing system of the input 120. The module 110 then selects the other writing system of the pair as being the writing system for the different, second form.

In alternative implementations, the module 110 automatically selects the different, second form from forms of queries in a query log of the user 122. As an example, the input 120 is in a first form. The module 110 identifies and selects, without further user intervention, the different, second form as being the form of the most queries in the query log.

The representations of the first input suggestions in a different, second form are identified as being second input suggestions. The translation service 130 returns the second input suggestions to the suggestion service 125. The translation service 130 also returns data identifying associations between the first input suggestions and the second input suggestions. An association indicates that a particular second input suggestion is a representation in a second form of a particular first input suggestion in a first form.

The module 110 receives the first input suggestions, second input suggestions, and associations from the suggestion service 125. The first input suggestions and the second input suggestions are all distinct from the input 120.

The module 110 can present the first input suggestions and second input suggestions to the user 122 in real time, i.e., as the user 122 is typing characters in the search engine query input field. For example, the module 110 can present a first group of first input suggestions and second input suggestions associated with a first character typed by the user 122, and present a second group of first input suggestions and second input suggestions associated with a sequence of the first character and a second character in response to the user 122 typing the second character in the sequence.

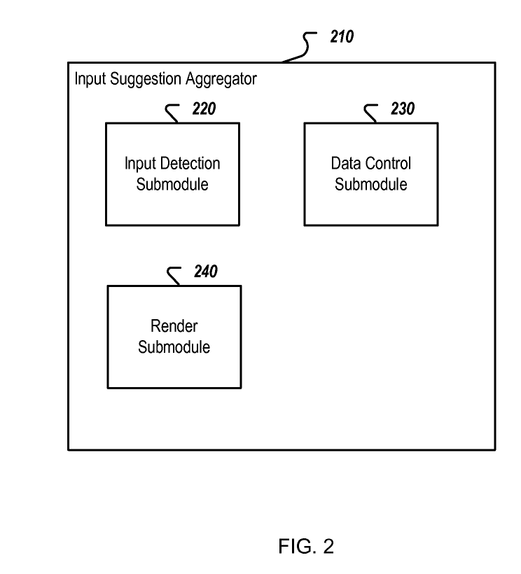

FIG. 2 is a block diagram illustrating an example input suggestion aggregator 210. The input suggestion aggregator 210 includes an input detection submodule 220, a data control submodule 230, and a render submodule 240. These functions performed by these components can be combined or subdivided into components in ways other than those shown in FIG. 2 and can be distributed on two or more computing devices. The input detection submodule 220 detects input entered in a search engine query input field.

The data control submodule 230 communicates with a suggestion service, e.g., suggestion service 125. In some implementations, the data control submodule 230 includes an event handler, e.g., an Ajax handler. The event handler generates calls to a communication engine, e.g., an Ajax engine, that sends asynchronous requests, e.g., XMLHttp requests, for input suggestions to the suggestion service. In some implementations, the data control submodule 230 generates a call to the communication engine immediately after each token of a textual input, e.g., after each character of a first search query or each word of a first search query, is received at the search engine query input field. As a result, input suggestions can be provided to the user as the user types each token of the textual input. In some alternative implementations, the data control submodule 230 implements a delay, waiting a predetermined amount of time before automatically making the request to the two or more suggestion services. The predetermined amount of time is specified in the module 110. The predetermined amount of time can be any amount of time, e.g., 1 ms, 150 ms, greater than 0. In practice, the predetermined amount of time typically falls in a range between 1 ms and 500 ms. In some implementations, the user 122 specifies the predetermined amount of time by setting user preferences.

The data control submodule 230 receives first input suggestions, second input suggestions, and associations between first input suggestions and second input suggestions from the suggestion service and sends the input suggestions to the render submodule 240.

The render submodule 240, e.g., a render engine that generates, as output, HyperText Markup Language (HTML) and Cascading Style Sheets (CSS) data in response to asynchronous requests, provides the output for rendering and display to the user as the input suggestions are received from the suggestion service. In some implementations, the render submodule 240 generates the output such that the first input suggestions and second input suggestions are rendered for display in distinct portions of a user interface. The render submodule 240 generates the output such that each second input suggestion is associated with a respective first input suggestion that the second input suggestion represents.

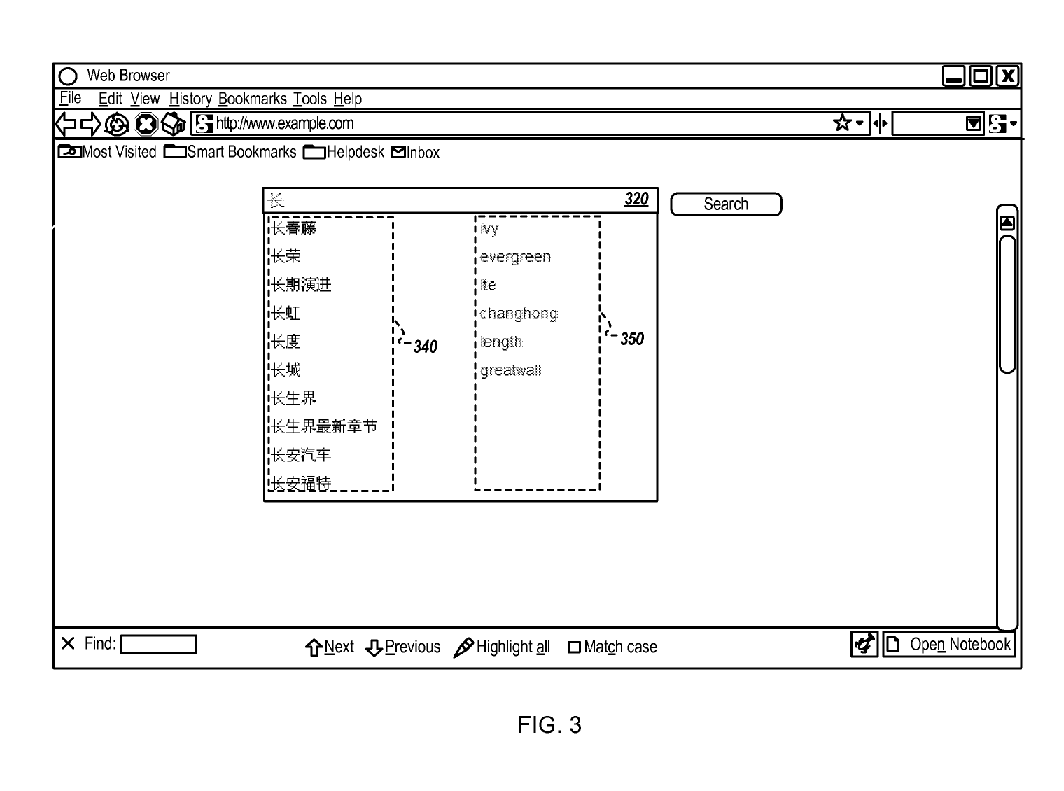

In some implementations, the associations are represented visually by aligning associated input suggestions. As an example, the first input suggestions can be rendered in a first vertical column and the second input suggestions can be rendered in a second vertical column that is adjacent to the first vertical column. A particular second input suggestion that is a translation or transliteration of a particular first input suggestion is rendered such that the particular first input suggestion and particular second input suggestion are aligned horizontally to each other in their respective columns (as illustrated in FIG. 3 and described below).

In some implementations, the associations are represented visually through visual indicators. As an example, the first input suggestions can be rendered in a first numbered list and the second input suggestions can be rendered in a second numbered list. A particular second input suggestion that is a translation or transliteration of a particular first input suggestion is rendered such that the particular first input suggestion and particular second input suggestion appear next to a same number in their respective lists. As another example, a particular second input suggestion that is a translation or transliteration of a particular first input suggestion can be rendered such that the particular first input suggestion and particular second input suggestion are rendered with a same color scheme, e.g., a same font color, a same background color.

FIG. 3 is a screenshot illustrating an example of a web page presenting a group of first input suggestions in a first form and a group of second input suggestions in a different, second form. The web page includes a search query input field 320. The search query input field 320 includes a search query “ [symbol] ”, e.g., “cháng” in Romanized Chinese meaning “long” in English, or “zhäng” in Romanized Chinese meaning “elder” in English. Input suggestions were requested from the suggestion service by the input suggestion aggregator 210.

The input suggestion aggregator 210 receives first input suggestions and provides the first input suggestions for display in an interface element of the web browser showing the web page. In the example of FIG. 3, the interface element is a drop-down menu showing first input suggestions that are expansions of the Hanzi character “ [symbol] ”, e.g., “ [symbol] ” meaning “ivy” in English, and “ [symbol] ” meaning “Evergreen”, an airline, in English.

In the example of FIG. 3, the input suggestion aggregator 210 is configured to request first input suggestions and second input suggestions before the user submits a request for a search, e.g., by pressing an “Enter” key or selecting a “Search” button on the web page. The input suggestion aggregator 210 provides the first input suggestions and the second input suggestions for display in distinct portions, e.g., a first portion 340 and a second portion 350, of a same interface element, e.g., a drop-down menu. Because the first input suggestions and second input suggestions are displayed in distinct portions, a user can easily distinguish between a first input suggestion and a second input suggestion.

In the example of FIG. 3, associations between first input suggestions and second input suggestions are also represented visually by the horizontal alignments of particular first input suggestions and particular second input suggestions. A first input suggestion “ [symbol] ” is horizontally aligned with a second input suggestion “ivy”, which is a translation of “ [symbol] ”. A first input suggestion “ [symbol] ” is horizontally aligned with a second input suggestion “Evergreen”, which is a translation of “ [symbol] ”.

One or more first input suggestions may not be associated with second input suggestions. In the example of FIG. 3, first input suggestions that are not associated with second input suggestions are not aligned with second input suggestions. As an example, a first input suggestion “ [symbol] *” is not aligned with a second input suggestion. Rather, the first input suggestion “ [symbol] ” can be considered to be aligned with a blank space. The entire sequence of Hanzi characters “ [symbol] ” does not have a meaningful representation in English. Note, however, that separately, “ [symbol] ” can mean “Chang'an” (capital of China during the Tang Dynasty) in English, and “ [symbol] ” can mean “car” in English.

When a user selects one of the input suggestions, the input suggestion aggregator 210 sends the selection in a request for a search, and a web browser instance is redirected to a web page displaying search results generated by a search engine for the selected input suggestion.

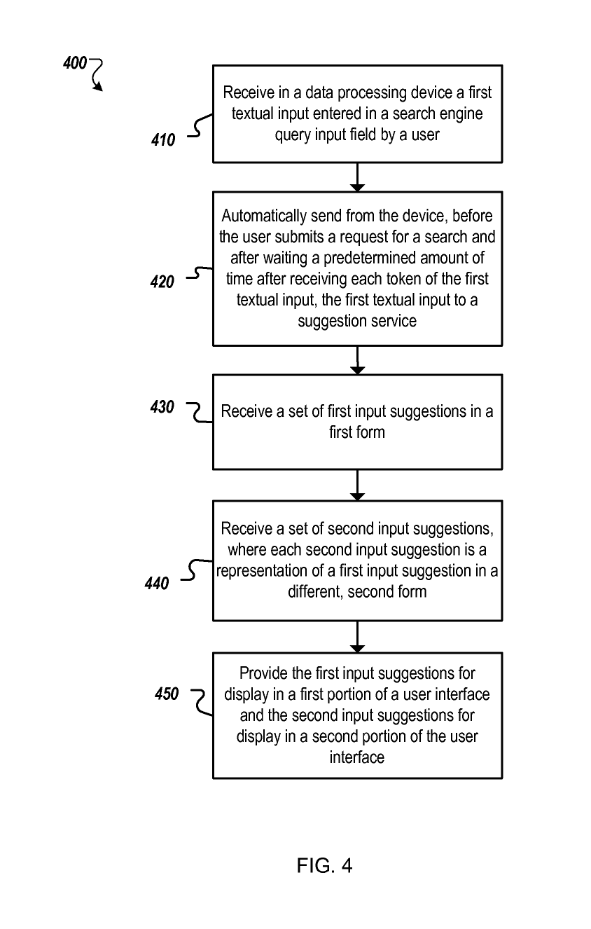

FIG. 4 is a flow chart showing an example process 400 for automatically generating input suggestions in different forms of representing natural languages. The process 400 includes receiving 410 in a data processing device a first textual input entered in a search engine query input field by a user. The first textual input is in a first form. The process 400 also includes automatically sending 420 from the device, before the user submits a request for a search and after waiting a predetermined amount of time after receiving each token of the first textual input, the first textual input to a suggestion service.

The process 400 also includes receiving 430 a set of first input suggestions in the first form, where each first input suggestion is textually different from the first textual input and selectable as an alternative to the first textual input. The process also includes receiving 440 a set of second input suggestions. Each second input suggestion is a representation of a first input suggestion in a different, second form and selectable as an alternative to the first textual input. The process also includes providing 450 the first input suggestions for display in a first portion of a user interface and the second input suggestions for display in a second portion of the user interface. The first portion is distinct from the second portion.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

As an alternative to the appended claims, the present invention may be defined by any of the following embodiments: In a first embodiment, a method comprises: receiving in a data processing device a first textual input entered in a search engine query input field by a user, where the first textual input is in a first form; automatically sending from the device, before the user submits a request for a search and after waiting a predetermined amount of time after receiving each token of the first textual input, the first textual input to a suggestion service; receiving a set of first input suggestions in the first form, where each first input suggestion is textually different from the first textual input and selectable as an alternative to the first textual input; receiving a set of second input suggestions, where each second input suggestion is a representation of a first input suggestion in a different, second form and selectable as an alternative to the first textual input; and providing the first input suggestions for display in a first portion of a user interface and the second input suggestions for display in a second portion of the user interface, where the first portion is distinct from the second portion.

In a second embodiment according to first embodiment, the displaying includes displaying each second input suggestion such that the second input suggestion is aligned with a respective first input suggestion that the second input suggestion represents.

In a third embodiment according to first or second embodiment, the method further comprises: receiving a user selection of a first input suggestion or a second input suggestion; and sending the selection in a request for a search.

In a fourth embodiment according to any of the first to third embodiments, the device is an intermediate server that receives the first textual input from a client computer.

In a fifth embodiment according to any of the first to fourth embodiments, the device is a client computer directly controlled by the user.

In a sixth embodiment according to any of the first to fifth embodiments, displaying the first input suggestions and the second input suggestions includes displaying the first input suggestions in the first portion and the second input suggestions in the second portion of a same interface element in the user interface.

In a seventh embodiment according to any of the first to sixth embodiments, the method can further comprise receiving user preferences specifying the second form.

In an eighth embodiment according to any of the first to seventh embodiments, the first form is a first writing system, and the second form is a different, second writing system.

In a ninth embodiment according to the eighth embodiment, the first form is for a first natural language, and the second form is for a different, second natural language.

In a tenth embodiment according to any of the first to ninth embodiments, the first form is a first writing system for a first natural language, and the second form is the first writing system for a different, second natural language.

In an eleventh embodiment according to any of the first to tenth embodiments, the different second form is selected from forms of queries in a query log of the user.

In a twelfth embodiment according to any of the first to eleventh embodiments, the different second form is selected from forms of queries in a query log of the user.

In a thirteenth embodiment according to any of the first to twelfth embodiments, the predetermined amount of time is in a range of 1 ms to 500 ms.

In a fourteenth embodiment, a system comprises: a machine readable storage device including a program product; and one or more processors operable to execute the program product and perform operations comprising: receiving in a data processing device a first textual input entered in a search engine query input field by a user, where the first textual input is in a first form; automatically sending from the device, before the user submits a request for a search and after waiting a predetermined amount of time after receiving each token of the first textual input, the first textual input to a suggestion service; receiving a set of first input suggestions in the first form, where each first input suggestion is textually different from the first textual input and selectable as an alternative to the first textual input; receiving a set of second input suggestions, where each second input suggestion is a representation of a first input suggestion in a different, second form and selectable as an alternative to the first textual input; and providing the first input suggestions for display in a first portion of a user interface and the second input suggestions for display in a second portion of the user interface, where the first portion is distinct from the second portion.

In a fifteenth embodiment according to the fourteenth embodiment, displaying includes displaying each second input suggestion such that the second input suggestion is aligned with a respective first input suggestion that the second input suggestion represents.

In a sixteenth embodiment according to the fourteenth or fifteenth embodiment, the operations further comprise: receiving a user selection of a first input suggestion or a second input suggestion; and sending the selection in a request for a search.

In a seventeenth embodiment according to any of the fourteenth to sixteenth embodiments, the operations further comprise: receiving a user selection of a first input suggestion or a second input suggestion; and sending the selection in a request for a search.

In an eighteenth embodiment according to any of the fourteenth to seventeenth embodiments, the device is an intermediate server that receives the first textual input from a client computer.

In a nineteenth embodiment according to any of the fourteenth to eighteenth embodiments, the device is a client computer directly controlled by the user.

In a twentieth embodiment according to any of the fourteenth to nineteenth embodiments, displaying the first input suggestions and the second input suggestions includes displaying the first input suggestions in the first portion and the second input suggestions in the second portion of a same interface element in the user interface.

In a twenty-first embodiment according to any of the fourteenth to twentieth embodiments, the operations further comprise: receiving user preferences specifying the second form.

In a twenty-second embodiment according to any of the fourteenth to twenty-first embodiments, the first form is a first writing system, and the second form is a different, second writing system.

In a twenty-third embodiment according to any of the fourteenth to twenty-second embodiments, the first form is for a first natural language, and the second form is for a different, second natural language.

In a twenty-fourth embodiment according to any of the fourteenth to twenty-third embodiments, the first form is a first writing system for a first natural language, and the second form is the first writing system for a different, second natural language.

A twenty-fifth embodiment includes a computer program product, encoded on a computer readable medium, operable to cause data processing apparatus to perform operations comprising: receiving in a data processing device a first textual input entered in a search engine query input field by a user, where the first textual input is in a first form; automatically sending from the device, before the user submits a request for a search and after waiting a predetermined amount of time after receiving each token of the first textual input, the first textual input to a suggestion service; receiving a set of first input suggestions in the first form, where each first input suggestion is textually different from the first textual input and selectable as an alternative to the first textual input; receiving a set of second input suggestions, where each second input suggestion is a representation of a first input suggestion in a different, second form and selectable as an alternative to the first textual input; and providing the first input suggestions for display in a first portion of a user interface and the second input suggestions for display in a second portion of the user interface, where the first portion is distinct from the second portion.

A twenty-sixth embodiment includes a computer program product, encoded on a computer readable medium, operable to cause data processing apparatus to perform operations according to any of the first to thirteenth embodiments.

What is claimed is:

1. A method comprising:
receiving in a data processing device a first textual input entered in a search engine query input field by a user, where the first textual input is in a first form;
automatically sending from the device, before the user submits a request for a search and after waiting a predetermined amount of time after receiving each token of the first textual input, the first textual input to a suggestion service;
receiving a set of first input suggestions in the first form, where each first input suggestion is textually different from the first textual input and selectable as an alternative to the first textual input;
receiving a set of second input suggestions, where each second input suggestion is a representation of a first input suggestion in a different, second form and selectable as an alternative to the first textual input; and
providing the first input suggestions for display in a first portion of a user interface and the second input suggestions for display in a second portion of the user interface, where the first portion is distinct from the second portion.

2. The method of claim 1, where the displaying includes displaying each second input suggestion such that the second input suggestion is aligned with a respective first input suggestion that the second input suggestion represents.

3. The method of claim 1, further comprising:
receiving a user selection of a first input suggestion or a second input suggestion; and
sending the selection in a request for a search.

4. The method of claim 1, where the device is an intermediate server that receives the first textual input from a client computer.

5. The method of claim 1, where the device is a client computer directly controlled by the user.

6. The method of claim 1, where displaying the first input suggestions and the second input suggestions includes displaying the first input suggestions in the first portion and the second input suggestions in the second portion of a same interface element in the user interface.

7. The method of claim 1, further comprising:
receiving user preferences specifying the second form.

8. The method of claim 1, where the first form is a first writing system, and the second form is a different, second writing system.

9. The method of claim 8, where the first form is for a first natural language, and the second form is for a different, second natural language.

10. The method of claim 1, where the first form is a first writing system for a first natural language, and the second form is the first writing system for a different, second natural language.

11. A system comprising:
a machine readable storage device including a program product; and
one or more processors operable to execute the program product and perform operations comprising:
receiving in a data processing device a first textual input entered in a search engine query input field by a user, where the first textual input is in a first form;
automatically sending from the device, before the user submits a request for a search and after waiting a predetermined amount of time after receiving each token of the first textual input, the first textual input to a suggestion service;
receiving a set of first input suggestions in the first form, where each first input suggestion is textually different from the first textual input and selectable as an alternative to the first textual input;
receiving a set of second input suggestions, where each second input suggestion is a representation of a first input suggestion in a different, second form and selectable as an alternative to the first textual input; and
providing the first input suggestions for display in a first portion of a user interface and the second input suggestions for display in a second portion of the user interface, where the first portion is distinct from the second portion.

12. The system of claim 10, where the displaying includes displaying each second input suggestion such that the second input suggestion is aligned with a respective first input suggestion that the second input suggestion represents.

13. The system of claim 10, where the operations further comprise:
receiving a user selection of a first input suggestion or a second input suggestion; and
sending the selection in a request for a search.

14. The system of claim 10, where the device is an intermediate server that receives the first textual input from a client computer.

15. The system of claim 10, where the device is a client computer directly controlled by the user.

16. The system of claim 10, where displaying the first input suggestions and the second input suggestions includes displaying the first input suggestions in the first portion and the second input suggestions in the second portion of a same interface element in the user interface.

17. The system of claim 10, where the operations further comprise:
receiving user preferences specifying the second form.

18. The system of claim 10, where the first form is a first writing system, and the second form is a different, second writing system.

19. The system of claim 18, where the first form is for a first natural language, and the second form is for a different, second natural language.

20. The system of claim 10, where the first form is a first writing system for a first natural language, and the second form is the first writing system for a different, second natural language.

21. A computer program product, encoded on a computer readable medium, operable to cause data processing apparatus to perform operations comprising:
receiving in a data processing device a first textual input entered in a search engine query input field by a user, where the first textual input is in a first form;
automatically sending from the device, before the user submits a request for a search and after waiting a predetermined amount of time after receiving each token of the first textual input, the first textual input to a suggestion service;
receiving a set of first input suggestions in the first form, where each first input suggestion is textually different from the first textual input and selectable as an alternative to the first textual input;
receiving a set of second input suggestions, where each second input suggestion is a representation of a first input suggestion in a different, second form and selectable as an alternative to the first textual input; and
providing the first input suggestions for display in a first portion of a user interface and the second input suggestions for display in a second portion of the user interface, where the first portion is distinct from the second portion.
